(19) United States
(12) Patent Application Publication
(10) Pub. No.: US 2016/0129382 A1
(43) Pub. Date: May 12, 2016

(54) FILTER MEDIA RECYCLING SYSTEM

(71) Applicant: William Bloomfield, Calgary (CA)

(72) Inventor: William Bloomfield, Calgary (CA)

(21) Appl. No.: 14/515,206

(22) Filed: Oct. 15, 2014

Related U.S. Application Data
(60) Provisional application No. 61/891,258, filed on Oct. 15, 2013.

(51) Int. Cl. B01D 41/02; B03B 5/56

(52) U.S. Cl. CPC B01D 41/02; B03B 5/56

(57) ABSTRACT

A system for isolating reusable filter media from worn media is provided, including a water tank having a first filter, the water tank providing water to a feed tank; the feed tank having a vibrating separator to separate reusable filter media in the feed tank from worn media in the feed tank and water; the vibrating separator including first and second screens sized to separate the reusable filter media and worn media, respectively; wherein the reusable filter media is retrievable from the feed tank; wherein the water provided to the feed tank is led from the feed tank back to the water tank; and a means for transporting filter media from a filtering vessel to the feed tank.

This application claims the benefit of U.S. Provisional Patent Application No. 61/891,258 filed Oct. 15, 2013, which is hereby incorporated by reference in its entirety.

### FIELD

This technology relates to recycling systems and, more particularly, to systems for recycling filter media.

### BACKGROUND

Depth filtration systems are common in many industries to remove contaminants from fluid streams. Deep bed media filtration is used particularity in oil fields to remove fine oil droplets and solid from water before injecting it into an injection well for disposal, or to remove particulate material from surface waters used for waterflood injection. After a filter bed in such a filtration system has been used for a period of time, the media becomes loaded with dirt and other contaminants, which may eventually lead to the filter becoming completely clogged. To remedy this, the filter bed is periodically backwashed (or regenerated) to free dirt and other contamination from the filter particles and flush them away. Also, there are systems available for the removal of valuable components from the filtered fluid, and for removing components from drilling muds.

End users have been disposing the entire media once it has become worn enough to cause problems with filtration and/or the backwash/regeneration systems. Media in such a state is referred to as worn media, or fines. An issue with worn media is that the worn media and broken fragments of the media cause plugging issues and reduced contaminant holding capacity. Some of the fragments may plug internal components and form a surface load creating high differential pressure, reduced flow, and reduced operating time.

Disposal of the worn media is often costly as it may contain hazardous materials like crude oil and oilfield or industrial by products. The media itself is also expensive, some costing several thousands of dollars per ton, plus freight and handling costs.

Further, in some cases like walnut shell media, the used media that is worn a little and rounded and free of walnut shell husk and walnut meat is more effective than the original media and the walnut shell media is more resilient once it has worn to a rounded form. The rounded walnut shell media is also free from the meat and husk (contaminant) elements that are present in the new walnut shell media.

Industrial end users require quick turn around when working on vessels. Filter media is generally screened dry at the factory to size tolerance. Surface tensions of liquid saturated media make wet screening difficult. Therefore, the liquid in filters that are operational present an issue with screening: it would take too long to dry the media before screening at the end point process facility. Dryers large enough to accomplish this process would be cost prohibitive to make portable. The challenge is to screen as fast as is economical and work within space limitations around the process facility equipment. End users also want to inspect/service vessels after media is out of the vessel. Currently end users use a vacuum truck to remove media and dispose of it. There are significant costs to handle the media and also to purchase new media that had some contaminant like meat and husk in the walnut shells.

### SUMMARY

Examples of this technology relate to a system and method to recover good media from worn media, thereby allowing the good media to be re-used. The savings could be more than half the cost of new media, and the freight, disposal and handling costs required in replacing the media. The recycling process provides end users with the ability to store their recycled media while inspection, repair and/or cleaning of the internal components of the filtration system occur.

The recycling system is designed to remove media from the filtration vessel, wet screen the media, remove the unusable worn media for disposal, and fill bulk bags with good media and recycled worn media.

Large volumes/high flow rates of water are used in the system. Therefore, a water reuse system is provided to reduce costs and complications, if an end user hasn't adequate water and drainage systems. Water becomes the motive force to help media pass through the screening device so water flow is required in both screening and keeping the liquid slurry from plugging hoses and piping.

A system for isolating reusable filter media from worn media is provided, including a water tank having a first filter, the water tank providing water to a feed tank; the feed tank having a vibrating separator to separate reusable filter media in the feed tank from worn media in the feed tank and water; the vibrating separator including first and second screens sized to separate the reusable filter media and worn media, respectively; wherein the reusable filter media is retrievable from the feed tank; wherein the water provided to the feed tank is led from the feed tank back to the water tank; and a means for transporting filter media from a filtering vessel to the feed tank.

The means for transporting filter media from the filtering vessel to the feed tank may include means for directing water from the water tank to the filtering vessel; mixing water from the water tank with filter media draining from the filtering vessel to produce a slurry; and a means for transporting the slurry to the feed tank.

The mixing of the filter media and the water from the water tank may include a fitting, fluidly connected to the filtering vessel and the water tank, the fitting allowing water to mix with the filtering media from both the direction of the filtering vessel and the direction of the water tank.

The water from the water tank may be further directable to a spray wash system inside the filtering vessel. The water may flow through the first and second screens before flowing back to the water tank. Gravity may cause the water to flow through the first and second screens before flowing back to the water tank. The water from the water tank may be further directable to a spray wash system in the feed tank. A third tank may be positioned to receive water from the feed tank and provide water to the water tank, the third tank having a second filter.

The vibrating separator may be a round vibrating screener, a rectangular separator, or a rotary drum separator. The feed tank may have a third screen to remove mud balls or tar balls present in the filter media.

A method of recycling reusable filter media is provided, including providing a water tank containing water; flowing water from the water tank into a feed tank, the feed tank containing a reusable media and worn media; screening the water and filter media in the feed tank through a vibrating separator having first and second screens sized to separate the reusable media and worn media, respectively; and retrieving the separated reusable media from the feed tanks

The filter media may be introduced to the feed tank by mixing filter media from a filtering vessel with water provided from the water tank to create the slurry, and transporting the slurry to the feed tank. The water that flows through the feed tank may flow into the water tank. The reusable media may be stored until re-introduced into the filter vessel.

### DESCRIPTIONS OF THE DRAWINGS

FIG. 1 is a diagram of an example of a media filtering system; and

FIG. 2 is a diagram of a detailed view of an example of a fitting used in the example of the media filtering system shown in FIG. 1.

### DETAILED DESCRIPTION

A detailed description of one or more embodiments of this technology is provided below along with accompanying figures that illustrate the principles of this technology. This technology is described in connection with such embodiments, but this technology is not limited to any embodiment. The scope of this technology is limited only by the claims and this technology encompasses numerous alternatives, modifications and equivalents. Numerous specific details are set forth in the following description in order to provide a thorough understanding of this technology. These details are provided for the purpose of example and this technology may be practiced according to the claims without some or all of these specific details. For the purpose of clarity, technical material that is known in the technical fields related to this technology has not been described in detail so that this technology is not unnecessarily obscured.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of this technology means an embodiment of this technology, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise. The term “herein” means “in the present application, including anything which may be incorporated by reference”, unless expressly specified otherwise.

The term “e.g.” and like terms mean “for example”, and thus does not limit the term or phrase it explains. For example, in a sentence “the computer sends data (e.g., instructions, a data structure) over the Internet”, the term “e.g.” explains that

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Where two or more terms or phrases are synonymous (e.g., because of an explicit statement that the terms or phrases are synonymous), instances of one such term/phrase does not mean instances of another such term/phrase must have a different meaning For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. section 1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes this technology claimed herein, or is essential to this technology claimed herein, or is coextensive with this technology claimed herein, except where it is either expressly stated to be so in this specification or expressly recited in a claim.

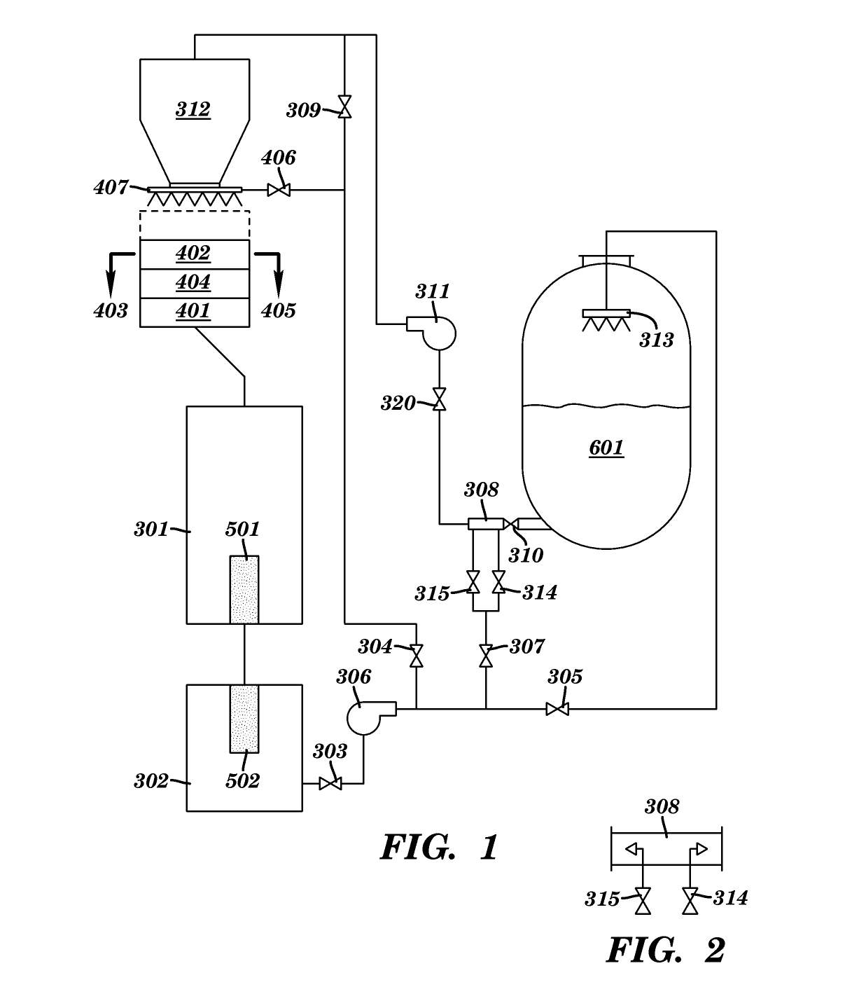

Referring to FIG. 1, a system according to this technology is shown. To begin recycling, first tanks 301 and 302 are filled with water. Valves 303 and 304 are then opened to allow water to flow into water recycle pump 306. Water recycle pump 306 is switched on to allow the recycling system to operate with water alone; ensuring pump 306 has low or minimum flow at this point. Valves 307, 309, 314, and 315 are opened to allow water flow into the solid liquid flow line and thin out the slurry content therein. Slurry pump 311 is then started and the flow line filled and water is pumped to conical bottom feed tank 312. Water alone flows to vibrating separator 401 during system start up. The water flows by gravity through to vibrating separator 401 to tank 301, then flows through filter screen 501 back to tank 302 and through another safety filter screen 502. The water then returns to pump 306. Shut off valve 320, if needed, may be positioned between pump 311 and fitting 308.

Once water is flowing through the system, vibrating separator 401 is turned on. Vibrating separator 401 includes two screens 402 and 404 and an optional third screen could be added if mud balls or tar balls are present (or other agglomerated media bound with contaminants). Screen 402 should be sized approximately 10% larger than the reusable media. Screen 402 and the motion of the separator are adjusted to allow the unusable worn media, i.e. fines, to pass through screen 402 when it arrives through slurry fitting 308 piping and feeder 312. Screen 404 is sized so that it captures a majority of the unusable worn media for removal and disposal. Valve 310 is generally part of filter vessel 601 and becomes part of the flow regulation and shut off. Valve 310 is shut off first when the system is stopped to allow water to flush out the solid media from slurry piping system. Fitting 308 is part of the media slurry system and allows water to mix with the media from both directions. Valve 314 on fitting 308 regulates the flow into the fitting 308 and directs water into filter vessel 601 and the concentrated media. Valve 315 on fitting 308 regulates flow while spray system 313, which may be a plurality of nozzles, directs water down the pipe to keep a minimum flow of water resulting in a high concentration of water in the slurry piping system. Once the recycling system is flowing with water, media outlet valve 310 can be progressively opened to allow media to flow at a rate that vibrating screen 401 can efficiently handle. FIG. 2 displays a detailed view of an example of fitting 308.

As the media and water slurry flows to vibrating separator 401, a water spray wash system 407 is started by opening valve 406. The spray wash system provides a secondary flush of flowing water to the media as it passes over vibrating screen panel 402. The secondary flush helps increase the efficiency removal of the unusable worn media fragments. The reusable worn media flows to bulk bag 403 where it deposits until full and is then stored until ready to be reloaded in the filter vessel 601 system.

The unusable worn media, or fines, passes by gravity through the vibrating separator with the water to screen 404. Screen 404 is sized to remove the majority of fines. The screen size is chosen based on dewatering capabilities of the unusable worn media. If screen 404 is too fine the system may flood. The unusable worn media is conveyed by vibrating separator 401 where it is dewatered to bulk bag 405 for later disposal. The water with some very small fragments falls by gravity to tank 301. Some of the fines will settle by gravity to the bottom of tank 301. Safety filter screens 501 and 502 stop the fines from discharging to tank 302. Alternatively, one big tank can be used in larger installations, but two or more small tanks may be used when space is limited.

Periodically valve 305 is opened to allow water to flow to spray system 313. Spray system 313 is designed to spray water to the back of vessel 601 (opposite the media outlet) and create a flow of shells to the media outlet valve 310.

To reduce water usage, the system employs a closed loop. The slurry pumping should have a significant amount of water flowing through so that the piping does not plug with a high concentration of solids. Water can also be added to the feed line through valve 309 and into the feed tank 312.

A round vibrating screener may be used as vibrating separator 401 as it is compact and can separate and dewater both the reusable and unusable worn media. A rectangular separator and rotary drum separator can also be employed as vibrating separator 401 but cost and sizing (e.g. fitting into plant areas where the filters are located) is a consideration. Vibrating separator 401 can have two or three screens depending on the presence of oversized materials such as tar balls or mud balls. A venturi vacuum system can also be employed in place of pump 311, although additional steady flow means and controls may be necessary for efficient operation.

The system according to one or more examples of this technology offers several advantages over the prior art. The system separates unusable worn media from reusable media efficiently; and in order to keep the total costs of replacement media and disposal of worn media to a minimum, the system should be as efficient as possible. The size of the system can vary to accommodate smaller spaces and provides high volume recycling when fast turnaround on larger systems is required.

The system includes an integral water recycling system that uses as little water as possible. The unusable media, or slurry, is efficiently transported to eliminate plugging in the piping system that is common with the transport of solid liquid slurries. This plugging can create down times and reduce revenue and profit.

The system uses high volumes of water as the transport/motive force to pass the media through vibrating separator 401. The filters in the system reduce water usage plugging. Gravity is used when applicable to reduce pumping and allow for simpler operational control.

The system according to one or more examples of this technology can be adjusted based on user preferences. Typically a user will have a required “specification” for media, and screens 402 and 404 can be adjusted to recycle media meeting the specification and allowing media not meeting the specification (i.e. off specification media) to be disposed.

The above-described embodiments have been provided as examples, for clarity in understanding this technology. For example while the media discussed above is walnut shell media, this technology can be used with other media, such as eastern black walnut shells, English walnut shells, coconut shells, peach pits and mineral media such as sand, anthracite, and garnet, as well as carbons, granular plastics and ion exchange resins. A person with skill in the art will recognize that alterations, modifications and variations may be effected to the embodiments described above while remaining within the scope of this technology as defined by claims appended hereto.

I claim:

1. A system for isolating reusable filter media from worn media, comprising:
a water tank having a first filter, the water tank providing water to a feed tank; the feed tank having a vibrating separator to separate reusable filter media in the feed tank from worn media in the feed tank and water;
the vibrating separator including first and second screens sized to separate the reusable filter media and worn media, respectively;
wherein the reusable filter media is retrievable from the feed tank; and
wherein the water provided to the feed tank is led from the feed tank back to the water tank; and
a flow line to transport filter media from a filtering vessel to the feed tank.

2. The system of claim 1 wherein the flow line to transport filter media from the filtering vessel to the feed tank comprises:
a second flow line directing water from the water tank to the filtering vessel;
a mixer for mixing water from the water tank with filter media draining from the filtering vessel to produce a slurry; and
a third flow line for transporting the slurry to the feed tank.

3. The system of claim 2 wherein the mixing of the filter media and the water from the water tank comprises a fitting, fluidly connected to the filtering vessel and the water tank, the fitting allowing water to mix with the filtering media from both the direction of the filtering vessel and the direction of the water tank.

4. The system of claim 2 wherein water from the water tank is further directable to a spray wash system inside the filtering vessel.

5. The system of claim 1 wherein the water flows through the first and second screens before flowing back to the water tank.

6. The system of claim 4 wherein gravity causes the water to flow through the first and second screens before flowing back to the water tank.

7. The system of claim 5 wherein water from the water tank is further directable to a spray wash system in the feed tank.

8. The system of claim 3 further comprising a third tank positioned to receive water from the feed tank and provide water to the water tank, the third tank having a second filter.

9. The system of claim 1 wherein the vibrating separator is a round vibrating screener.

10. The system of claim 1 wherein the vibrating separator is a rectangular separator.

11. The system of claim 1 wherein the vibrating separator is a rotary drum separator.

12. The system of claim 1 wherein the feed tank has a third screen to remove mud balls or tar balls present in the filter media.

13. A method for recycling reusable filter media, the method comprising:
providing a water tank containing water;
flowing water from the water tank into a feed tank, the feed tank containing a reusable media and worn media;
screening the water and filter media in the feed tank through a vibrating separator having first and second screens sized to separate the reusable media and worn media, respectively; and
retrieving the separated reusable media from the feed tanks.

14. The method of claim 13 wherein the filter media is introduced to the feed tank by mixing filter media from a filtering vessel with water provided from the water tank to create the slurry, and transporting the slurry to the feed tank.

15. The method of claim 13 wherein water that flows through the feed tank flows into the water tank.

16. The method of claim 13 wherein reusable media is stored until re-introduced into the filter vessel.

17. A system for isolating reusable filter media from worn media, the system comprising:
a water tank having a first filter, the water tank providing water to a feed tank; the feed tank having a vibrating separator to separate reusable filter media in the feed tank from worn media in the feed tank and water;
the vibrating separator including first and second screens sized to separate the reusable filter media and worn media, respectively;
wherein the reusable filter media is retrievable from the feed tank; and
wherein the water provided to the feed tank is led from the feed tank back to the water tank; and
means for transporting filter media from a filtering vessel to the feed tank.

18. The system of claim 17 wherein the flow line to transport filter media from the filtering vessel to the feed tank comprises:
means for directing water from the water tank to the filtering vessel;
means for mixing water from the water tank with filter media draining from the filtering vessel to produce a slurry; and
means for transporting the slurry to the feed tank.
